(19) United States
(12) Patent Application Publication
(10) Pub. No.: US 2005/0155446 A1
(43) Pub. Date: Jul. 21, 2005

(54) Gear shifting cassette system

(76) Inventor: Ian Heathcote, Staffordshire (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/502,028

(22) PCT Filed: Jan. 24, 2003
(86) PCT No.: PCT/EP03/00722

(30) Foreign Application Priority Data
Jan. 25, 2002 (GB) 0201657.4

(51) Int. Cl. F16H 63/20

(52) U.S. Cl. 74/473.25

(57) ABSTRACT

A cassette unit 11, which acts between the shift rails 7, 8, 9, 10 and the actuation unit 5 of the transmission, is provided for adapting a transmission 1 to various customer wishes in regard to equipping the transmission 1 with respectively individual actuation units, for example electrical, pneumatic or manual actuation units. All, or at least a large part, of the functions which are to be respectively determined individually, for example traverse limitation, restoring forces, reverse gear blockage, etc. are combined in the cassette unit 11. It therefore constitutes an intermediate module, which acts like an adapter between the actuation unit 5 and the shift rails 7, 8, 9, 10 and, moreover, also includes functional customizing. By means of this it is possible to open up a wide range of application cases for a standard transmission, which is adapted to the respective special type of use solely by means of a change of the cassette.

The invention relates to a gear shifting cassette unit for a gear shifting mechanism, to a gear shifting assembly, and to a transmission having a gear shifting assembly.

### BACKGROUND OF THE INVENTION

Gear shifting assemblies for mechanical change gear transmissions comprising a plurality of generally parallel, independently axially movable shift rails to be selected and axially moved to effect engagement/disengagement of a particular gear ratio, are well known in the prior art, as may be seen by reference to U.S. Pat. Nos. 2,951,392; 4,455,883; 4,575,029; 4,567,785; 4,584,895 and 4,104,929.

Typically, such gear shifting assemblies include a shift finger fixed to a directly mounted shift lever or to a cross shaft of a remotely controlled shifting mechanism. Interlock mechanisms are usually provided to prevent movement of more than one shift rail at a time from the axially centered or neutral positions thereof. The cross shaft of the remotely controlled shifting mechanism extends across the shift bars. For selecting a shift rail, the cross shaft is axially moved in X-X direction (cross-gate travel). For axially moving the shift rail, selected by the shift finger of the cross shaft, the cross shaft is rotated (into gear direction or Y-Y direction). Hence, a X-Y type shifting mechanism is formed.

The cross shaft may be driven by electric motors, pneumatic or hydraulic actuators or cables.

Different original equipment manufactures (OEMs) often require different performances from their selector mechanisms. In particular, the operating forces, the biasing of the shift levers, and the lengths of the shift travels tend to vary. This is especially true in view of different shift bar housings envisaged by the customer. Depending upon the basic principle of the X-Y controller, the performance of the selector mechanisms may vary. This results in a large number of variations in the designs of the transmissions and their selector mechanisms.

### SUMMARY OF THE INVENTION

It is an object of the invention to simplify the assembly of transmissions and to reduce the number of variance of transmissions, that have to be built and that have to be stocked.

This object is attained by providing a drop-in cassette mechanism which contains individualizing means as for example the spring and/or other biasing means.

The shifting cassette unit is provided for a gear shifting mechanism for shifting a gear changing transmission with several axially movable shift rails. The latter have connecting members, for example in the form of cutouts, which can be engaged by a shifting element, for example a shift finger. An actuation unit is furthermore a part of the gear shifting mechanism in the form of an X-Y drive. The actuation unit should be mounted on an opening in the transmission housing and has a shift finger, which can be moved in the Y-Y direction, as well as in the X-X direction. The cassette of the invention should be arranged between the shift rails and the actuation unit for example. The cassette unit has a carrier member, which supports a shifting element. The latter engages the connecting elements of the shift rails in order to select and displace them. On the other end, the shift finger engages the carrier member, which thereupon is itself moved by the shift finger. Thus, the shift finger no longer directly enters into the shift rails, or their connecting elements (cutouts), but into the cassette unit.

Because of this it becomes possible to perform a large portion of the adaptations, which become necessary in connection with a transmission in regard to different X-Y actuation units, by selecting appropriate cassettes. This relates, for example, to the shape of the shift finger, its size and the length of its traversing movements in the X-X direction and in the Y-Y direction, the length of the shift finger, and the like. Different actuation units can work together with the same shift fingers, wherein the cassette acts as an adapter module. When producing different transmission types it is therefore possible to omit the adaptation of the actual transmission to various requirements regarding the X-Y gear shifting unit, i.e. in the individual case the adaptation is limited to the selection of the respectively adapted cassette unit.

The cassette units can be exchanged in a simple way, so that existing transmissions can also be adapted later, i.e. in the completely mounted state, to different tasks or types of employment. An opening is provided in the transmission housing, through which the shift rails can be accessed. As a rule, the X-Y gear shifting mechanism operates through this opening. With the present invention, the cassette unit in accordance with the invention is simply attached to the opening, or is inserted into this opening.

Particularly simple adaptation and maintenance is made possible if the cassette unit has a flange as the fastening means, which is maintained at the edge of the transmission housing opening. For example, the flange can be clamped between the X-Y gear shifting mechanism and the transmission housing.

The cassette unit contains a traversing member, which is guided by a corresponding guidance device, for example a linear guidance device, in the X-X direction. Guide surfaces of the cassette housing can be used for this. This results in a simple construction. The traversing member has a guidance device for the carrier member. The guidance device can be, for example, a linear guidance device in the form of an elongated opening oriented in the Y-Y direction. The carrier member is then seated in this opening, and has, on its side facing the shift rails, one or several projections as shift elements, and, on its side remote from the shift rails, a coupling element for connecting the shift finger. The coupling element is constituted, for example, by two projections or prongs of the carrier member located in the slit of the traversing member, between which the shift finger can enter. The latter moves the carrier member in the Y-Y direction by resting against the prongs of the carrier member and, by resting against the flanks of the oblong opening in which the prongs are seated, moves the traversing member in the X-X direction.

The traversing element can be provided with a blocking device in order to dependably prevent erroneous actuations of the transmission. The blocking element can be used in particular to prevent more than one shift rail being moved out of its neutral position at one time. The blocking element is preferably fixedly connected with the traversing member. For example, it is embodied as an oblong protrusion or rib, which enters into cutouts of the shift rails through an opening in the cassette housing.

The cassette can contain further elements required for customizing the transmission. These are, for example, a biasing device, which sets a preferred X-X position of the traversing member. The desired spring forces and characteristic spring curves are therefore preset in the cassette in accordance with his requirements. They can be changed by changing the cassette. Furthermore, means for limiting the path of the gear shifting elements can be provided in the cassette. For example, the path in the X-X direction can be limited by appropriate detent elements. In this respect, customizing of the transmission again takes place merely by changing cassettes.

If a particularly short shifting path is desired, in particular in the X-X direction, something which can often be the case with manually shifted transmissions, the gear shifting mechanism preferably has two tongues, which are intended to engage the shift rails. The shift rails are arranged in pairs next to each other, wherein pairs of shift rails are arranged at somewhat greater distances from each other. In this case the distances of the shift rails and of the tongues are matched to each other in such a way, that a tongue can respectively only select one of a pair of shift rails among the shift rails. The respectively other shift rail is then located in a space between tongues. However, the fork formed by the tongues is so narrow that only one shift rail of adjoining pairs of shift rails can be selected, wherein the respectively other tongue then always projects into the space between the pairs of shift rails.

Further details of advantageous embodiments of the invention ensue from the remaining dependent claims, the drawings or the description.

### BRIEF DESCRIPTION OF THE DRAWINGS

FIG. 1 illustrates a gear shifting assembly in a lateral view,

FIG. 2 shows the gear shifting assembly in FIG. 1 in a partially exploded view,

FIG. 3 shows the gear shifting assembly in FIGS. 1 and 2 in a basic representation,

FIG. 4 is a perspective representation of the transmission housing of the gear shifting assembly in FIGS. 1 and 2,

FIG. 5 gear shifting mechanism,

FIG. 6 is a perspective representation of the cassette unit,

FIGS. 7 to 10 show the cassette unit in cross-sectional representations in several selection positions, and

FIG. 11 is a perspective representation of a shift rail of the gear shifting mechanism in FIG. 5.

### DESCRIPTION OF THE PREFERRED EMBODIMENT

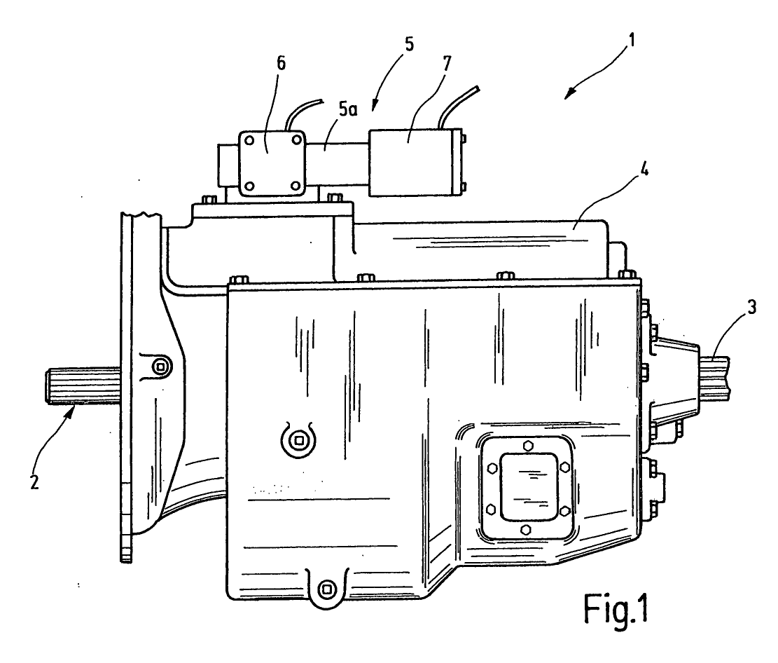

A transmission 1 with an input shaft 2, an output shaft 3 and a transmission housing 4 is represented in FIG. 1. An X-Y actuation unit 5 is provided on the transmission housing 4 which has, for example, an electric motor 6 as the X drive, and an electric motor 7 as the Y drive. The actuation unit 5 has a housing 5a, which is screwed together with the transmission housing. However, in place of the electrical X-Y actuation unit 5 it is possible to provide a shifting tower, which has a shift lever seated pivotably in the X direction and the Y direction and is directly connected with the shift finger.

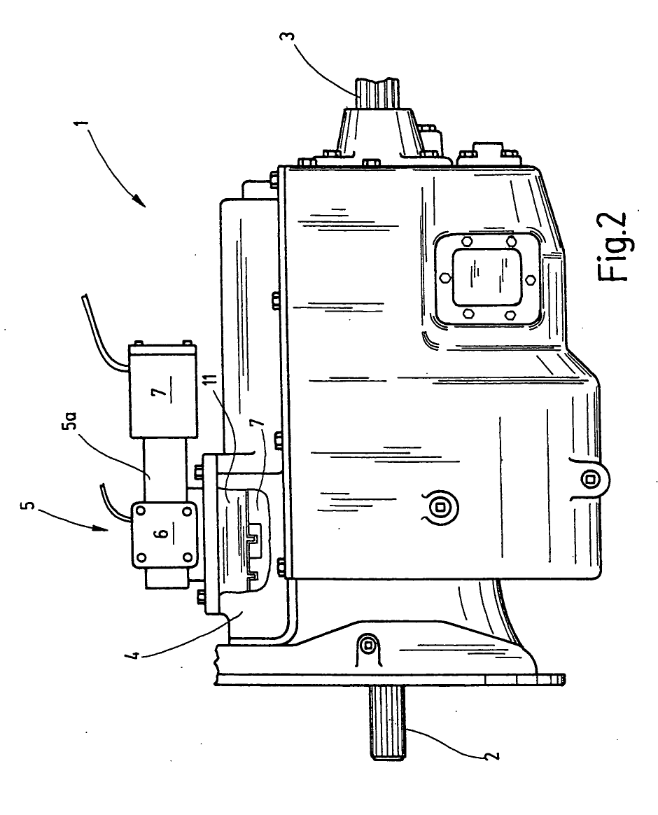

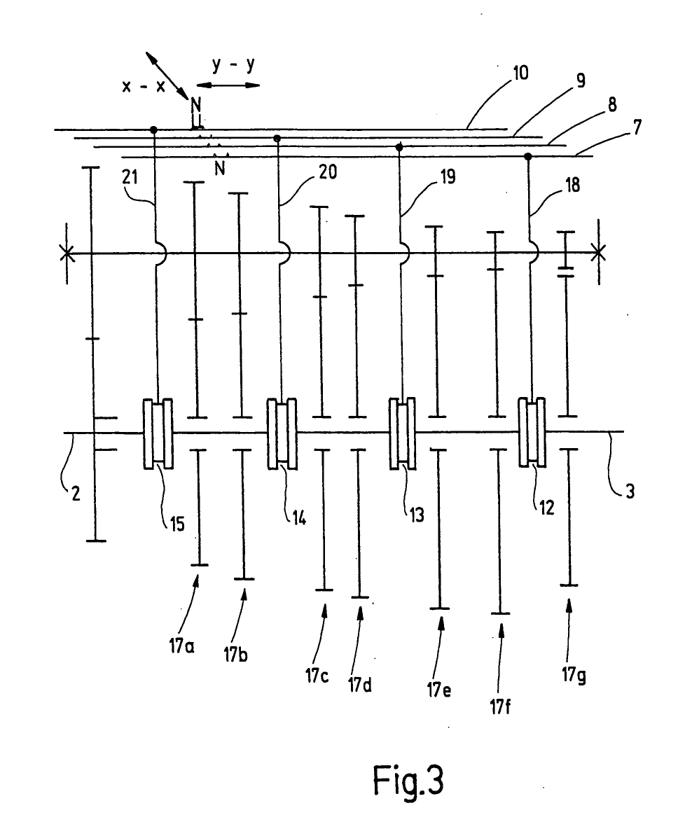

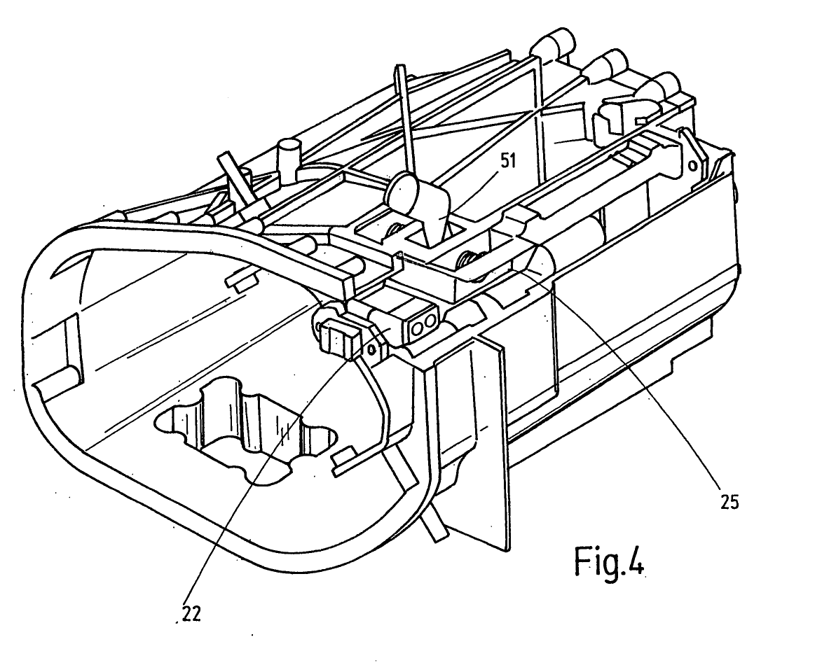

FIG. 2 illustrates the gear 1 in accordance with FIG. 1, wherein a portion of the transmission housing 4 below the actuation unit 5 is cut open. A shift rail 7 is visible through the opening. Further shift rails 8, 9, 10 can be seen in the schematic representation in accordance with FIG. 3 and the perspective representation in accordance with FIG. 4.

As can be seen from FIGS. 2 and 4, a cassette unit 11 is provided between the shift rails 7, 8, 9, 10 and the actuation unit 5, which is used to match the actuation unit with the shift rails 7, 8, 9, 10.

As shown in FIG. 3, the shift rails 7, 8, 9, 10 are used for actuating clutches 12, 13, 14, 15 in order to activate sets of gear wheels 17a, 17b, 17c, 17d, 17e, 17f, 17g, which are parts of different gears, or alternatively to provide a direct drive connection between the output shaft 3 and the input shaft 2. To this end, the shift rails 8, 9, 10 each have at least one shift fork 18, 19, 20, 21. The shift forks 18, 19, 20, 21 position the respective clutches 12, 13, 14, 15 alternatively in a center neutral position or in a right position, in which they couple the gear wheel respectively on the right with the output shaft 3, or in a position displaced completely to the left, in which they couple the gear wheel respectively adjoining at the left (or the input shaft in case of the clutch 15) with the output shaft 3. The direction of movement of the clutches 12, 13, 14, 15 matches the axial direction of the shift rails 7, 8, 9, 10, and is identified as the Y-Y direction. The direction transversely to the shift rails 7, 8, 9, 10 is designated the X-X direction.

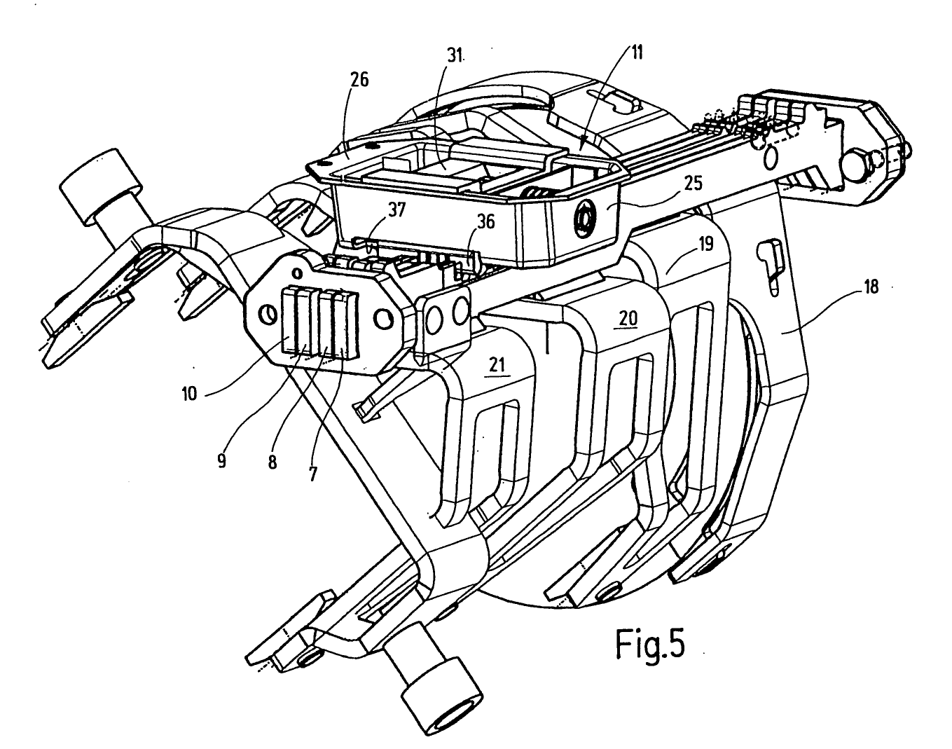

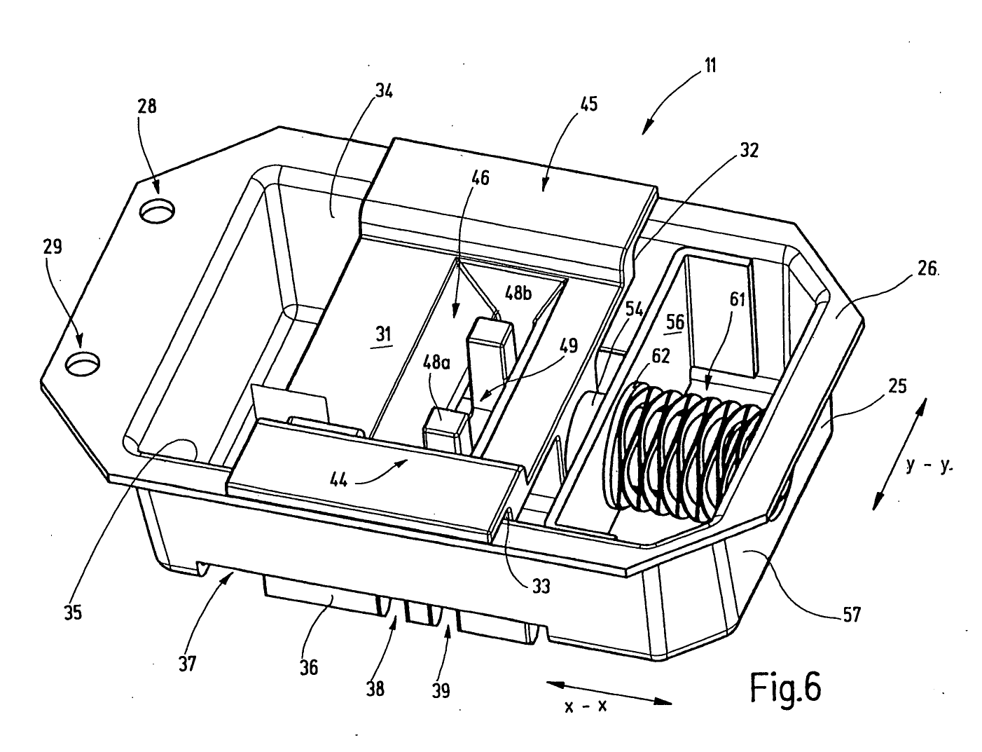

At its top, or if required at another surface, the transmission housing 4 has an opening 22, which adjoins the shift rails 7, 8, 9, 10. As can be seen in FIGS. 5 and 6, the cassette unit 11 is seated in this opening 22. Therefore the cassette unit 11 is to be inserted into a gear shifting mechanism 24 constituted by the actuation unit 5, the shift rails 7, 8, 9, 10 and the shift forks 18, 19, 20, 21. The cassette unit 11 has a flat, shell-like housing 25, approximately rectangular in a view from above, whose outer contour matches the contour of the opening 22. The housing 25 is provided with a circumferential flange-like edge 26, which rests on a corresponding contact surface 27, which surrounds the opening 22 of the transmission housing 4. For positioning the cassette unit 11, the edge 26 can be provided with one or several positioning openings 28, 29, to which corresponding alignment pins are assigned.

A traversing element 31 is arranged in the housing 25, which is seated displaceably in the X-X direction. For this purpose, the traversing element 31 has two guide faces 32, 33, which slide on corresponding inner surfaces 34, 35 of the housing 25 and are guided by it in this way. The maximum distance the traversing element 31 can travel is greater than, or at least as great, as is necessary for reaching all shift rails 7, 8, 9, 10.

A rib 36 extending in the X-X direction is provided on the underside of the traversing element 31, which projects through a corresponding slit-like opening 37 in the underside of the cassette housing 25. In the X-X direction, the opening 37 is longer than the rib 36 by the maximum traverse of the traversing element 31. The rib 36 is used to unblock and to block individual shift rails, and for this purpose has at least one, but preferably two cutouts 38, 39.

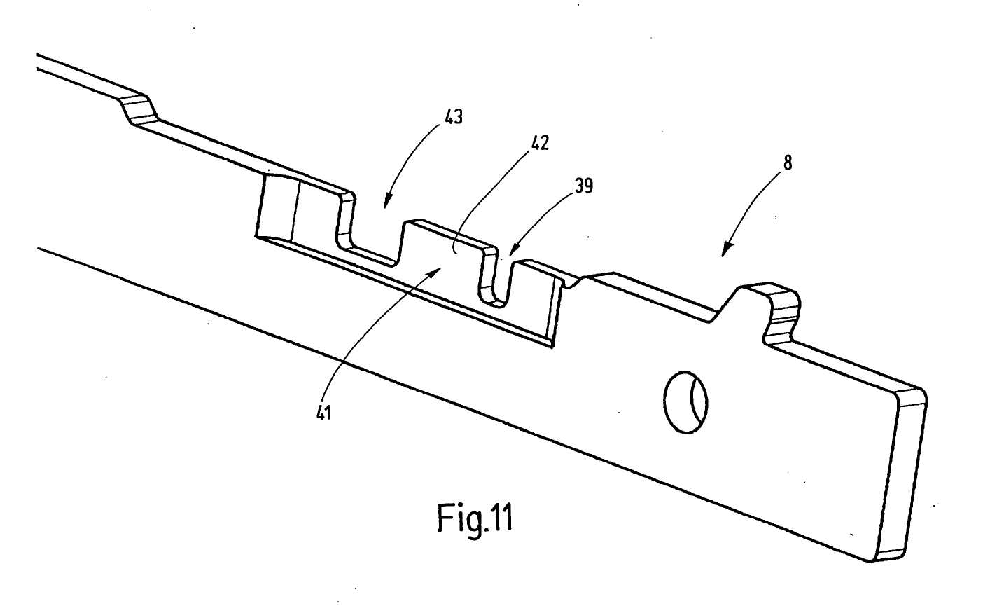

The rib 36 engages cutouts 39 provided in the shift rails. To make this clear, the shift rail 8 is separately illustrated in FIG. 11. The shift rail 7 is embodied mirror-reversed in respect to the shift rail 8. Both constitute a shift rail pair 7, 8 of closely spaced shift rails. A further shift rail pair is arranged at a somewhat greater distance from this shift rail pair and is constituted by the two shift rails 9, 10, which are embodied mirror-reversed in respect to each other. The shift rail 10 matches the shift rail 8. As made clear in FIG. 11, the shift rail 8 has a lateral flat section or cutout 41, in whose area the width of the shift rail 8 is reduced. The cutout 39, as well as a further, distanced cutout 43, which is used as connecting member, by means of which the shift rail is selected and actuated by a shift element, pass through a remaining wall area 42.

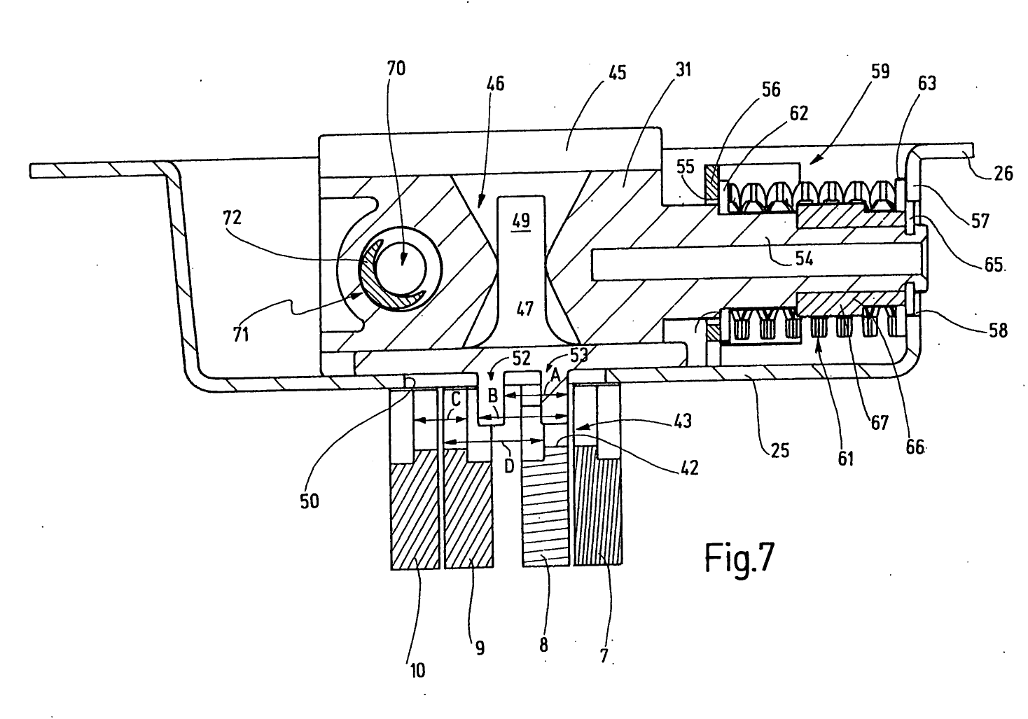

As can be seen in FIG. 6, the traversing element 31 has two wings 44, 45, which extend over the edge 26 and can glide on the edge 26. A slit 46 extending in the Y-Y direction is formed between the wings 44, 45, which widens in a funnel shape toward the top. The slit 46 is used for seating a carrier member 47, which can be seen in FIG. 7 in particular. It has two vertically projecting prongs 48a, 48b (FIG. 6), between which the shift finger 51, seen in FIG. 4, of the actuation unit 5 extends. Therefore the prongs 48a, 48b, together with the lateral flanks of the slit 46, constitute a coupling 49 for moving the carrier member 47 in a manner corresponding to the movements of the shift finger 51.

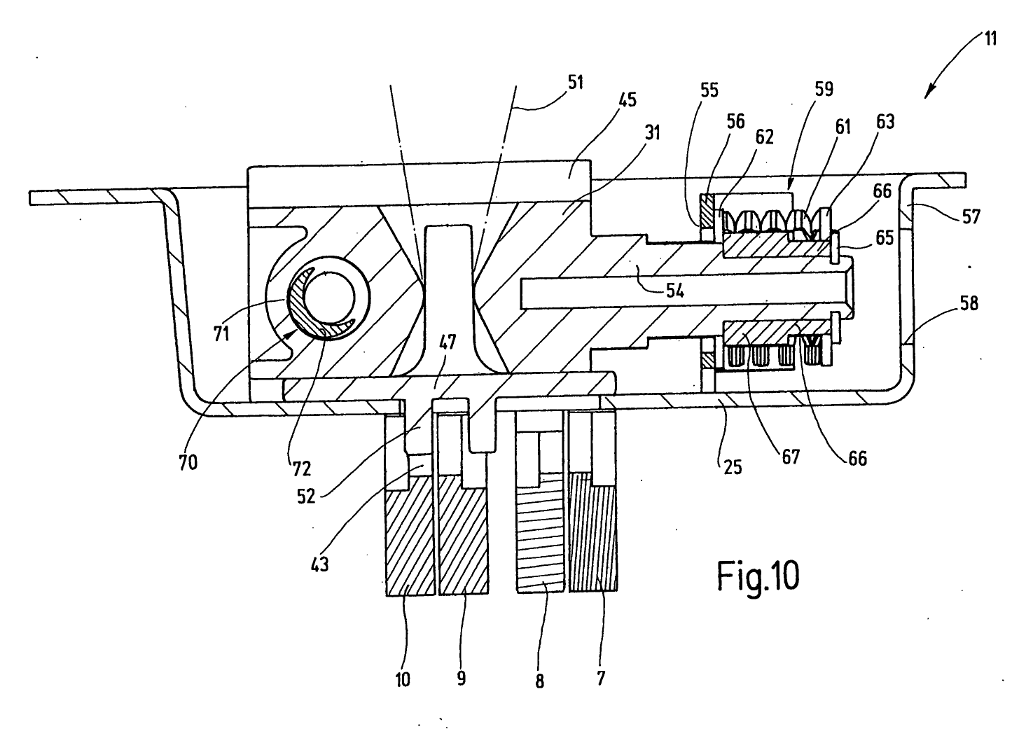

The carrier member 47, which can be moved in the Y-Y direction in respect to the traversing element 31, has two tongue-like extensions 52, 53 on its underside, which project away from the carrier member 47 at right angles in respect to the X-X direction and to the Y-Y direction. As illustrated in FIGS. 7 to 10, the extensions 52, 53 here project into the cutouts 43 of the shift rails 7, 8, 9, 10. As further illustrated in FIG. 7, the lateral spacing of the cutouts 43, the lateral spacing of the extensions 52, 53, and the spacing between the wall areas 42 of adjoining shift rails 7, 8, 9, 10 are matched to each other in the following way:
A>C, and
B<D,
wherein
A is the sum of the width of the space between the extensions 52 and 53 and the width of one extension,
B=the total width of the fork formed by the extensions 52 and 53, i.e. the distance between the outer surfaces, facing away from each other, of the extensions 52, 53 (FIG. 7),
C=the outer spacing between two adjoining interlocking elements constituted by the cutouts 43, i.e. the distance between the surfaces, facing away from each other, of the wall areas 42 and the shift rail pairs 9, 10, or 7, 8, and
D=the spacing of the outsides, facing in the same direction, of shift rails 8, 9 arranged at a greater spacing.

As can be further seen in FIGS. 5 to 10, the traversing element 31 is provided with a pin 54 extending in the X-X direction and projecting through an appropriate opening 55 in an intermediate wall 56 of the housing 25. A section 57 of the housing 25 aligned parallel with the intermediate wall 56 is also provided with an opening 58, through which the pin 54 can pass when the element 31 is appropriately displaced.

A spring biasing device 59 arranged on the pin 54 is maintained in the space formed between the intermediate wall 56 and the section 57. Part of this is a compression spring 61, for example in the form of a helical spring or of a plate spring package. The compression spring is maintained between two pressure disks 62, 63, seated on the pin 54. Here, the pressure disk 62 rests against an appropriate annular shoulder 64 of the pin 54, while the pressure disk 63 rests against a snap ring 65, which has been inserted into a corresponding groove at the free end of the pin 54. In this case the distance between the snap ring 65 and the annular shoulder 64 essentially corresponds to the distance between the intermediate wall 56 and the section 57.

The pin 54 moreover supports a traversing limit sleeve 66, which has a cylinder area 67 of increased diameter, which fits neither through the opening of the pressure disk 62 nor through the opening of the pressure disk 63.

While the spring biasing device 59 is used for setting a preferred position of the traversing element 31, a further spring biasing device 70 can be provided which, for example, is used for forming a perceptible obstacle, in particular for selecting one of the shift rails 7 or 10 located at the edges. Such an obstacle can be desirable if, for example, the respective shift rail is exclusively assigned to the reverse gears, and the selection of the same is intended to be permitted only by means of an intentional overcoming of a perceptible obstacle. The spring biasing device 70 can be constituted by a bore 71, which extends transversely to the X-X direction, and in which a spring element 72, for example in the form of a compression spring, is seated. The latter can bias a detent element, for example a detent projection or a detent ball, in a direction out of the bore 71. In this case a protrusion can be formed on the guide surface 34 or 35 which, when the element 31 has been moved correspondingly far, represents an obstacle which must be overcome by force and pushes the detent element into the bore 71.

The transmission 1 so far described operates as follows:

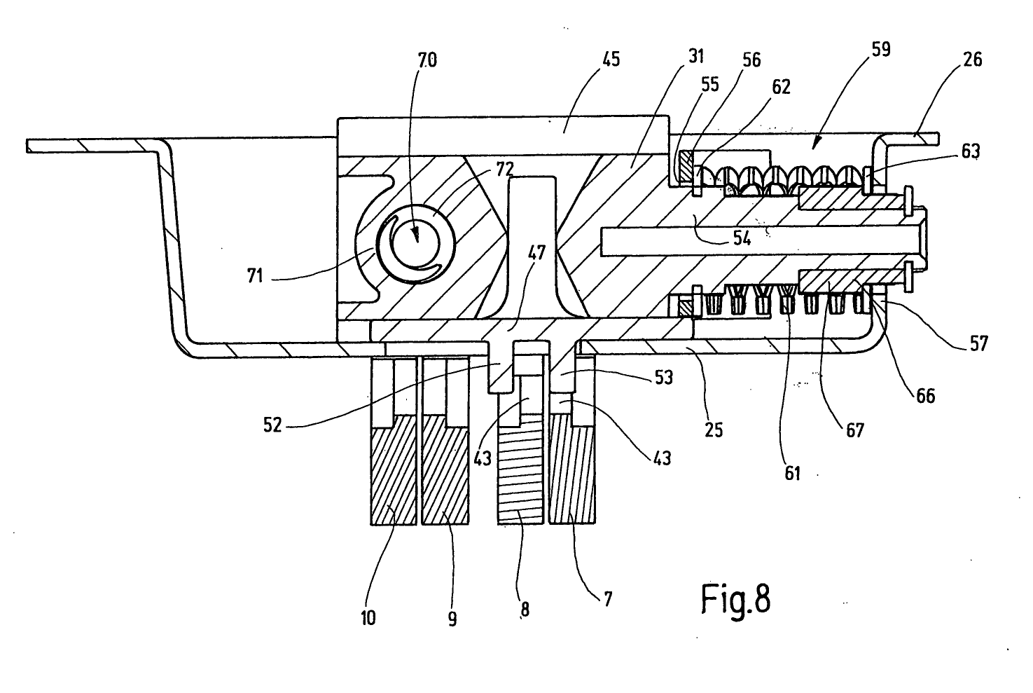

During operation, the actuation unit 5 first moves the shift finger 51 in the X-X direction for selecting a desired shift rail. In the course of this, the shift finger 51 (FIGS. 4 and 5) displaces the traversing element 31, which in turn takes the carrier member 47 along. Because of this, the extensions 52, 53 move along the course formed by the cutouts 43. In the position of rest (FIG. 7), the shift rail 8 is selected. If the shift rail 7 is to be selected, the shift finger 51 displaces the element 31 toward the right into the position illustrated in FIG. 8. There, the area 67 of the sleeve 66 comes to rest via the pressure disk 63 on the section 57 of the housing 25. The extension 53 is completely located within the cutout 43, while the extension 52 has not yet reached the cutout 43 of the shift rail 8. Now, a movement of the shift finger in the Y-Y direction causes an axial displacement of the shift rail 7, while all other shift rails 8, 9, 10 remain in their neutral position. They are moreover arrested in their neutral position by the rib 36. The opening 38 in the rib 36 only unblocks the shift rail 7.

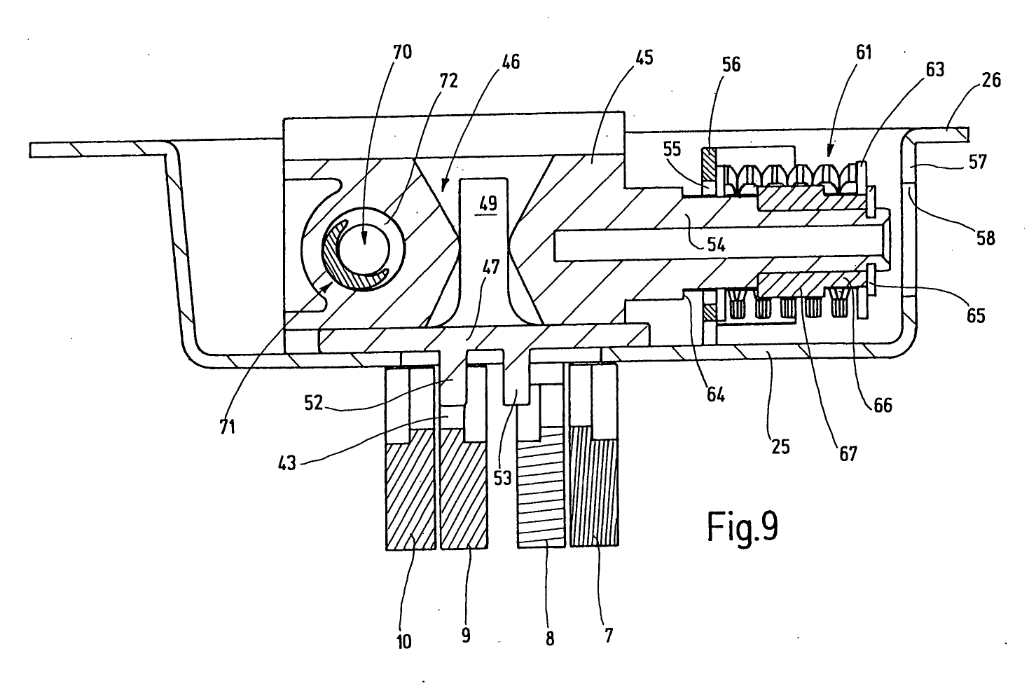

If, however, the shift rail 9 is to be selected, the element 31 is moved toward the left in accordance with FIG. 9 against the force of the compression spring 61, which is now supported on the intermediate wall 56 and is biased against the pressure disk 63, until the extension 52 has entered into the cutout 43 of the shift rail 9. Now the shift rail 9 is the only one selected and unblocked shift rail. All other shift rails 7, 8, 10 are arrested by the rib 36. Now the carrier member 46 is displaced in the Y-Y direction by means of a Y-Y movement of the shift finger, so that the desired gear is introduced.

If a gear assigned to the shift rail 10 is to be introduced, the element 31 is moved out of the neutral position of all shift rails toward the left by means of the shift finger 51 until the area 67 of the sleeve 66 comes to rest against the pressure disk 62 and, via it, against the intermediate wall 56. In this position the extension 52 is located inside the cutout 43 of the shift rail 10, which is therefore selected. The opening 38 in the rib 36 is correspondingly displaced, so that the shift rail 10 is also unblocked. The other shift rails 7, 8, 9 are blocked. A Y-Y movement of the shift finger 51 causes the displacement of the shift rail 10 out of its neutral position and the introduction of the desired gear.

The cassette unit 11 contains the essential elements required for matching a defined actuation unit 5 to a provided standard transmission 1. Initially, the shape and size of the shift finger 51 are matched to the shape and size of the shift is rails 7, 8, 9, 10 and their cutouts 43. In addition, the actuation forces in particular required in the transverse direction (X-X direction) can be set by the respective selection of an appropriate compression spring 61. The maximum traverse can furthermore be set by an appropriate selection of the sleeve 66. Finally, the characteristics of the spring biasing device 70 can be fixed. The desired shift patterns can be determined by an appropriate selection of the carrier member 47. If a long shift travel is acceptable, a carrier member 47 with a single extension for connecting the shift rail to be selected is sufficient. If short shift travels are desired, the carrier member 47 can be provided with two extensions 52, 53, as illustrated in FIGS. 7 to 10. Thus, in the end matching the transmission 1 to various gear shifting mechanisms or gear shifting assemblies is limited to the exchange or provision of an appropriate cassette 11.

1. A gear shifting cassette unit for shifting of gears in a change gear transmission, the transmission comprising at least two shift rails
the cassette unit including:
a cassette housing comprising bearing means for movably supporting at least one shift element for engaging and moving the shift rails and a coupling for connecting the shift element to a shift finger.

2. The gear shifting cassette unit according to claim 1 comprising mounting means for fixedly securing the housing on a transmission housing in a position where the shift element can be moved to selectively engage.

3. The gear shifting cassette unit according to claim 2, wherein the housing of the cassette comprises, as the mounting means, a flange which is to be clamped between a surface surrounding an opening of the transmission housing and a housing of an actuation unit for moving the shift finger in an direction and direction.

4. The gear shifting cassette unit according to claim 1 wherein the shift element protrudes through an opening provided in the cassette housing for engaging the shift rails.

5. The gear shifting cassette unit according to claim 1 wherein the coupling for connecting the carrier member to the shift finger in the direction and the direction is provided on a carrier member.

6. The gear shifting cassette unit according to claim 1 wherein the bearing means comprises a traversing member located in the cassette housing movable in the direction and supporting the carrier member movable in the direction.

7. The gear shifting cassette unit according to claim 6 wherein the traversing member comprises two opposite guiding surfaces which are in sliding engagement with inner surfaces of the casing facing each other.

8. The gear shifting cassette unit according to claim 7, wherein the traversing number comprises an oblong opening with the carrier member located therein and movable in the direction.

9. The gear shifting cassette unit according to claim, claim 8, wherein a biasing device is associated with the traversing member.

10. The gear shifting cassette unit according to claim 9, wherein the biasing device comprises at least one spring means urging the traversing member into a desired position.

11. The gear shifting cassette unit according to claim 10, wherein the spring means is a compression spring.

12. The gear shifting cassette unit according to claim 11, wherein the traversing member comprises a shaft extending in direction and carrying the compression spring.

13. The gear shifting cassette unit according to claim 12, wherein the compression spring is clamped between two pressure disks located on the shaft between respective stop means.

14. The gear shifting cassette unit according to claim 13, wherein the casing of the cassette comprises two abutment means for the spring means limiting the travel of the spring means in opposite directions.

15. The gear shifting cassette unit according to claim 1, wherein a travel path limiting element is associated with the traversing member.

16. The gear shifting cassette unit according to claim 12, wherein the travel path limiting element is a sleeve located on the shaft.

17. The gear shifting cassette unit according to claim 7, wherein the traversing member comprises a blocking member for enabling the shift rail selected by the carrier member to move in the direction and for blocking all other shift rails in their neutral position.

18. The gear shifting cassette unit according to claim 17, wherein the blocking member extends in direction and engages the shift rails for blocking them in direction, and wherein the blocking member comprises at least one cutout for unblocking the shift rail that is in registration with the cutout.

19. The gear shifting cassette unit according to claim 17, wherein the casing comprises a slit-like opening and the blocking member is extending therethrough.

20. The gear shifting cassette unit according to claim 17, wherein the blocking member 3 is a one piece unit with the traversing member.

21. The gear shifting cassette unit according to claim 1, wherein two shift elements having the shape of tongues are provided which extend into shift rail connecting members and being spaced apart in the direction.

22. The gear shifting cassette unit according to claim 21, wherein the distance is provided between the tongues, which distance is greater than the width of the connecting member in the direction.

23. The gear shifting cassette unit assembly according to claim 21, wherein the transmission comprises at least three shift rails, two of them arranged in close distance so that, if one tongue is in regular registration with the connecting element of the selected shift rail, the other connecting element remains within the void between the tongues.

24. The gear shifting cassette unit according to claim 23, wherein two of the shift rails are arranged in far distance so that, if one tongue is in regular registration with the connecting element of a selected shift rail, the other tongue is not in registration with the connecting element of the other shift rail.

25. The gear shifting cassette unit according to claim 1, wherein the housing of the cassette has an outer shape that fits into an opening of the transmission.

26. A gear shifting mechanism comprising
at least two shift rails having a neutral position and being axially movable in an axial direction out of the neutral position for engaging a gear, each shift rail having a shift rail connecting member, and
a cassette unit.

27. Transmission having a gear shifting assembly including a gear shifting cassette unit and a gear shifting mechanism for shifting of gears in the transmission comprising a transmission housing,
said shifting mechanism comprising an actuation unit having a actuation unit housing to be mounted on the transmission housing, said actuation unit comprising a shift finger movable in the first axial direction for axially moving a selected one of the shift rails and in the second direction for selecting a shift rail,
the gear shifting assembly including:
a cassette housing having mounting means for fixedly securing the housing on the transmission housing in a position where the shift elements can be moved to selectively engage the connecting members of the shift rails,
a traversing member located on the cassette housing and movable in the direction,
the carrier member being supported by the traversing member and movable in the direction and being provided with the shift elements at one side thereof protruding through an opening provided in the cassette housing and engaging with a shift rail connecting member, the carrier member being provided with a coupling for connecting the carrier member to the shift finger in the direction and the direction.

28. The gear shifting cassette unit according to claim 15, wherein the travel path limiting element is a sleeve located on the shaft.
